(19) United States
(12) Patent Application Publication
(10) Pub. No.: US 2019/0000052 A1
(43) Pub. Date: Jan. 3, 2019

(54) DURABLE SNAGLESS SOFT-BODIED FISHING LURE

(71) Applicant: Scott Stephen Garman, Morro Bay, CA (US)

(72) Inventor: Scott Stephen Garman, Morro Bay, CA (US)

(21) Appl. No.: 15/616,747

(22) Filed: Jun. 28, 2017

(51) Int. Cl. A01K 85/02; A01K 83/02; A01K 85/16

(52) U.S. Cl. CPC A01K 85/02; A01K 85/16; A01K 83/02

(57) ABSTRACT

Disclosed herein are embodiments directed to a soft-bodied fishing lure which extends a fish hook when a fish bites on a back region of the lure. In its default or natural resting position, the soft-bodied fishing lure keeps the hook in a retracted state to prevent or otherwise substantially reduce the frequency of the hook becoming snagged on weeds, algae, and matted vegetation when the lure is being fished. In some embodiments, the hook may be secured to the soil-bodied fishing lure in a substantially vertical orientation by a set of nylon plastic members that were previously molded with the soft-body material of the lure. These nylon plastic members, which advantageously do not rust or exhibit the same sharp edging as metallic components, restrict motion of the hook in undesirable directions so as to substantially prevent engagement of the hook with the soft-body material of the lure.

### FIELD OF THE INVENTION

The present invention relates generally to fishing lures. More particularly, the present invention is directed in one exemplary aspect to a durable soft-bodied fishing lure which extends a fish hook when a fish bites on a back region of the lure.

### BACKGROUND OF THE INVENTION

Conventional fishing lures suffer from a variety of drawbacks. One of the most significant issues affecting many types of hard-bodied lures is that the fish hook remains exposed while the hard-bodied lure is being fished. Due to the hook's continual exposure, the hook will frequently become snagged on weeds, algae, grasses, reeds, tulle stalks, as well as other types of matted vegetation. As a result of the hook frequently becoming snagged (“hung up”) on the matted vegetation, the angler may become frustrated and simply avoid fishing in these locations altogether. This problem becomes exacerbated given that much of fishing is seasonal: during a topwater season, for example, a changing thermocline will often drive fish towards the matted vegetation in order to seek shade or to otherwise cool themselves. Thus, although these regions may at certain times of the year contain significant numbers of fish, fishing in these areas can be rendered impracticable because exposed fishing hooks are constantly becoming snagged on the matted vegetation that is present in these locations.

Over the years, attempts have been made to address the snagging issue, but with remarkably limited success. Many conventional hard-bodied lures simply utilize one or more strips of wire (or a wire loop) attached to, for example, a screw ring on the front of the lure. The wire is then extended and positioned in front of, or arranged to surround, the exposed fish hook. Although the wire is occasionally able to deflect or divert possible snags (for example, from fallen tree branches), the hook still remains exposed, and therefore it will still frequently become snagged on weeds, algae, and matted vegetation. As a result, these so-called “wire-guards,” which are sometimes haled by lure manufacturers as making their fishing lures “snagless,” “snagproof,” or “weedless,” actually accomplish very little towards reducing snag and hang-ups in the weeds.

Another class of hard-bodied lures utilize what are known as “spring-loaded” hooks. These devices require metal springs, screws, tensioned wired hooks, and hollowed-out lure bodies in order to function properly. The problem with these devices is that over time, they cease to function correctly due to grime buildup and/or oxidation inside of the lure. Rust is a common problem associated with oxidation, and can often lead to the degradation of certain metallic components, discoloration, and resistance to motion. That is to say, certain movable metallic components will often freeze-up or become “stuck” on account of the rust.

Many conventional soft-bodied lures also utilize exposed hooks, and therefore also suffer from frequent snagging issues. For example, conventional jigs utilize a lead or tungsten sinker with a hook molded into it and surrounded by a soft-body in order to attract fish. The hook, however, remains exposed during fishing, and is therefore also susceptible to becoming snagged.

Another type of conventional soft-bodied lure is known as a “hollow bodied frog.” These lures often utilize two stationary hooks positioned towards the back of the lure, with one hook on each side of the soft lure-body. Typically, the tips of these hooks point inwardly and barely touch the soft-body of the lure. A problem with hollow bodied frogs is that the close proximity between the tips of the hooks and the soft lure body material, along with the fact that a fish needs to bite the lure in order for the stationary hooks to penetrate the fish's mouth, can often result in tears and rips in the soft-body material of the lure. Conversely, bending or pulling the tips of the fish hooks (with a pair of pliers, for example) so that they point away from the soft-body material of the lure leads to increased snagging.

Conventional soft-bodied lures also cannot benefit from spring-loaded fish hooks as in the case of conventional hard-body lures. This is because spring-loaded fish hooks utilize metallic components, and in the case of a soft-bodied lure, the sharp edging of the metals would quickly cut or rip through the material used to form the soft body of the lure. Even without utilizing spring-loaded fish hooks, conventional soft-bodied lures still rapidly exhibit rips, tears, and rapid degradation due to repeated interactions with the sharp point of the fish hook. This happens for several reasons. To start, conventional rigging techniques (such as Texas rigging) have the point of the hook inserted through the nose of the lure, the point piercing back out of the lure from the inside and then the hook being fed through. The point of the hook then penetrates the lure yet again at a second location, with the point of the hook either remaining embedded inside the lure or again piercing through the lure body from the inside so that the point of the hook is barely exposed on the outside of the lure body. Repeated use of such conventional rigging techniques can quickly introduce tears and rips into the lure body due to the lure body repeatedly becoming engaged with the sharp point of the hook. Aside from these issues, there is nothing to keep a metal fish hook from tearing the lure when the hook is finally set upon the fish. The hook, after all, has been inserted into a soft-body material, so when the angler pulls on the line, the sharp point of the hook will often rip or tear the soft-body of the lure.

What is needed is a fishing lure that can keep a hook retracted until the fish bites down on the lure in order to substantially reduce snag and thereby enable fishing in areas with matted vegetation. What is also needed is a fishing lure that does not utilize metallic components, and will therefore not become susceptible to the adverse effects of oxidation/rust. What is still further needed is a fishing lure with a structure that is specifically tailored to prevent the point and barb of the fish hook from ripping, tearing, or otherwise damaging the soft-body material of the lure.

### SUMMARY OF THE INVENTION

In a first exemplary aspect, a fishing lure is disclosed. In one embodiment, the fishing lure includes a lure body comprising PVC plastisol, and a set of members, each of said members comprising nylon plastic, each of said members being at least partially disposed within the lure body, and each of said members being adapted to secure a fish hook to the lure body in a predetermined orientation, wherein the lure body is adapted to expose the fish hook upon experiencing a collapse of a back region of the lure body.

In another embodiment, the fishing lure includes a lure body comprising a groove adapted to at least partially surround a point of a fish hook when the fish hook is in a retracted position on the lure body, a first member disposed within the lure body and adapted to receive a fishing line inserted through the first member, the first member comprising a slot adapted to receive an eye of the fish hook attached to the fishing line, a second member at least partially disposed within the lure body and positioned lower on the lure body than the first member, the second member adapted to restrict lateral rotational motion of the fish hook relative to the lure body, and a third member disposed within the lure body and adapted to restrict downward rotational motion of the fish hook relative to the lure body.

### BRIEF DESCRIPTION OF THE DRAWINGS

FIG. 1A is a side view of an exemplary fishing lure with the fish hook in an extended position according to embodiments of the present invention.

FIG. 1B is a side view of an exemplary fishing lure with the fish hook in a retracted position according to the embodiments depicted by FIG. 1A.

FIG. 2 is a top perspective view of an exemplary fishing lure with the fish hook in a retracted position according to embodiments of the present invention.

FIG. 3A is a side perspective view of a nylon tube member adapted for use in an exemplary fishing lure according to embodiments of the present invention.

FIG. 3B is a front view of the nylon tube member depicted in FIG. 3A.

FIG. 3C is a top view of the nylon tube member depicted in FIG. 3A and FIG. 3B.

FIG. 3D is a back view of the nylon tube member depicted in FIGS. 3A-3C.

FIG. 4A is a side devotional view of a hook interfacing member adapted for use in an exemplary fishing lure according to embodiments of the present invention.

FIG. 4B is a front view of the hook interfacing member depicted in FIG. 4A.

FIG. 4C is a top view of the hook interfacing member depicted in FIG. 4A and FIG. 4B.

FIG. 5 is a top plan view of a nylon plate member adapted for use in an exemplary fishing lure according to embodiments of the present invention.

FIG. 6 is a top perspective view of an exemplary fishing lure with its lure body hidden from view according to embodiments of the present invention.

FIG. 7 is bottom perspective view of an exemplary fishing lure with part of its lure body hidden from view according to embodiments of the present invention.

FIG. 8 is a back view of an exemplary fishing lure according to embodiments of the present invention.

FIG. 9 is a side perspective view of an exemplary fishing lure according to embodiments of the present invention.

FIG. 10 is a bottom perspective view of an exemplary fishing lure according to embodiments of the present invention.

### DETAILED DESCRIPTION OF THE PREFERRED EMBODIMENTS

In the following description of preferred embodiments, reference is made to the accompanying drawings in which it is shown by way of illustration specific embodiments in which the invention can be practiced. Not all of the described components are necessarily drawn to scale in order to emphasize certain features and to better facilitate the reader's conception of the disclosed embodiments. It is to be understood that other embodiments can be used and structural changes can be made without departing from the scope of the embodiments of this invention.

Various embodiments of the present invention are directed to a soft-bodied fishing lure which extends a fish hook when a fish bites on a back region of the lure. In its default or natural resting position, the soft-bodied fishing lure keeps the hook in a retracted state to prevent or otherwise substantially reduce the frequency of the hook becoming snagged on weeds, algae, and matted vegetation when the lure is being fished. In some embodiments, the hook may be secured to the soft-bodied fishing lure in a substantially vertical orientation by a set of nylon plastic members that were previously molded with the soft-body material of the lure. These nylon plastic members, which advantageously do not rust or exhibit the same sharp edging as metallic components, restrict motion of the hook in undesirable directions so as to substantially prevent engagement of the hook with the soft-body material of the lure.

For retraction and subsequent extension of the fish hook, some embodiments utilize a principle that may be likened to that of squeezing a round rubber ball with your hand. While squeezing the rubber ball causes a deformation of its shape, releasing it causes the ball to return to its original shape. When holding the rubber ball in your hand and repeatedly squeezing it, successive actions and reactions take place. In some embodiments, the material utilized to form the body of the lure (e.g., PVC plastisol), exhibits similar characteristics as in this example of the rubber ball. Utilizing this principle, the need for a spring-loaded retractable hook (and therefore the need for the lure to utilize metallic springs, latches, screws, and/or tensioned wired hooks) therefore becomes obviated.

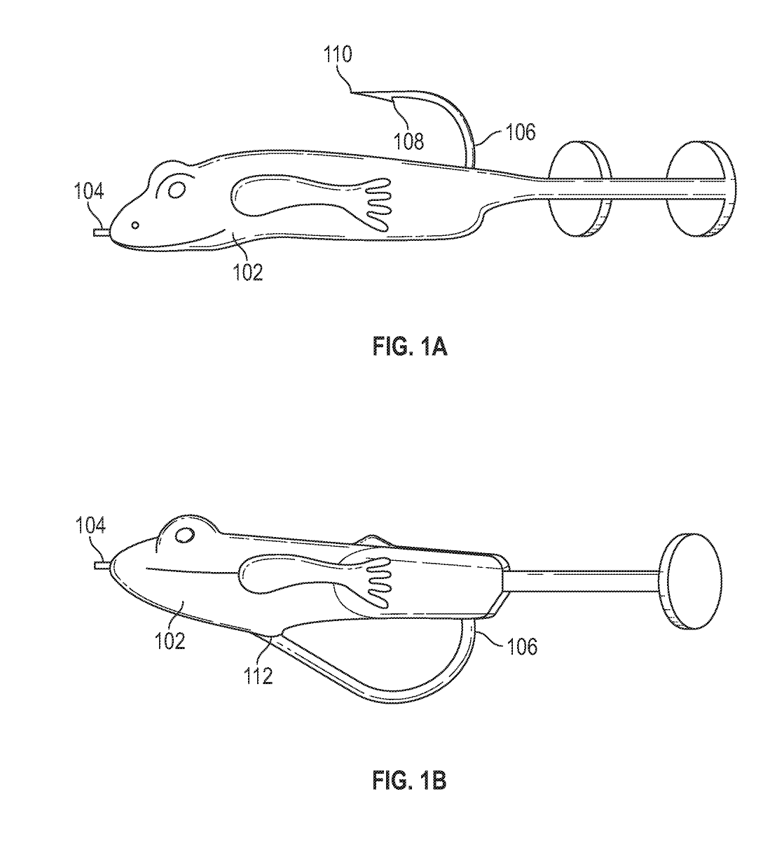

FIG. 1A is a side view of an exemplary fishing lure with the fish hook 106 in an extended position according to embodiments of the present invention, while FIG. 1B is a side view of an exemplary fishing lure with the fish hook 106 in a retracted position according to the embodiments depicted by FIG. 1A.

As shown by FIG. 1B, a fishing lure including a lure body 102 is configured to secure a fish hook 106 tied to a fishing line 104, the shank of the fish hook 106 extending out of a hole 112 in the belly of the lure body 102. In some embodiments, the fish hook 106 remains in a retracted position until a fish bites (and thereby applies both upward and downward forces) upon a back region of the lure. Upon this occurrence, the back end of the lure collapses and the bend and shank of the hook 106 spring upward, thereby exposing the point 110 and barb 108 of the hook 106. An exemplary hook 106 in its extended position is depicted in FIG. 1A.

Note that various types of fishing line 104 may be utilized according to embodiments of the present invention, including standard and braided types of fishing line, monofilament and fluorocarbon lines. In some embodiments, the fish hook 106 may be any type of standard-sized, straight-shank fish hook, although for purposes of the figures included herein, a 6/0 large-sized hook is depicted. Persons skilled in the art will readily appreciate that the size of the mold used to form the lure body 102 may be scaled larger or smaller in order to create lures accommodating fish hooks 106 of various other sizes.

According to preferred embodiments, the lure body 102 is formed from a thermoplastic liquid polymer known as PVC plastisol (sometimes called “PVC resin”); however, natural or synthetic rubbers may be used to form the lure body 102 in the alternative. Although the lure body 102 is depicted in the figures as resembling a frog, persons skilled m the art will readily appreciate that the lure body 102 can be formed to resemble rats, minnows, crawdads, worms, and myriad other alternative forms of bait.

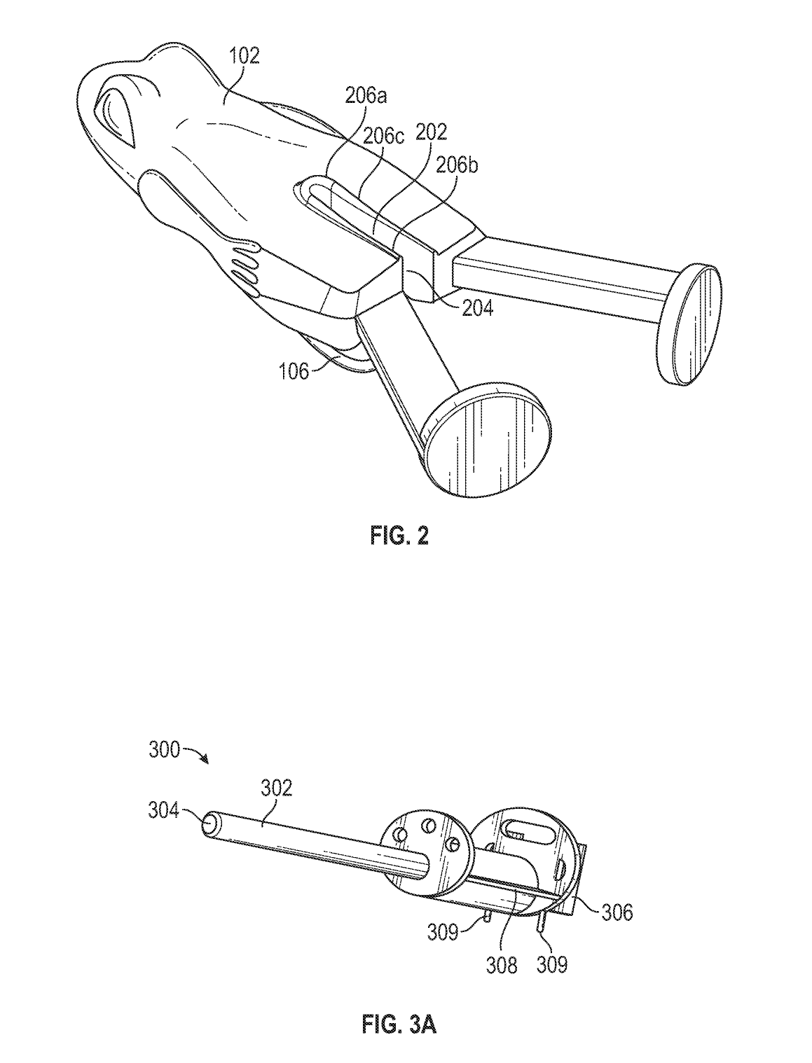

FIG. 2 is a top perspective view of an exemplary fishing lure with the fish hook 106 in a retracted position according to embodiments of the present invention. As shown by this figure, the lure body 102 may include a groove 202 that substantially surrounds the point 110 of the fish hook 106 (not visible in FIG. 2) while it remains in its retracted position. Regions of the lure body 102 surrounding the groove 202 may include a set of protrusions (206a-206c) which serve to further shield the fish hook 106 from becoming snagged on matted vegetation while it remains in its retracted state.

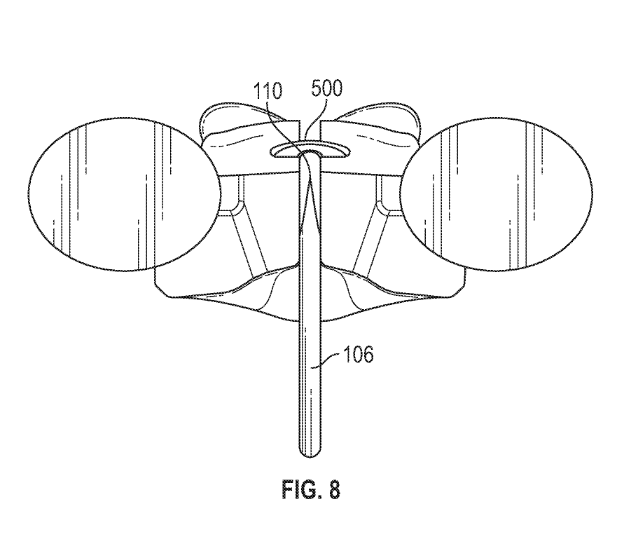

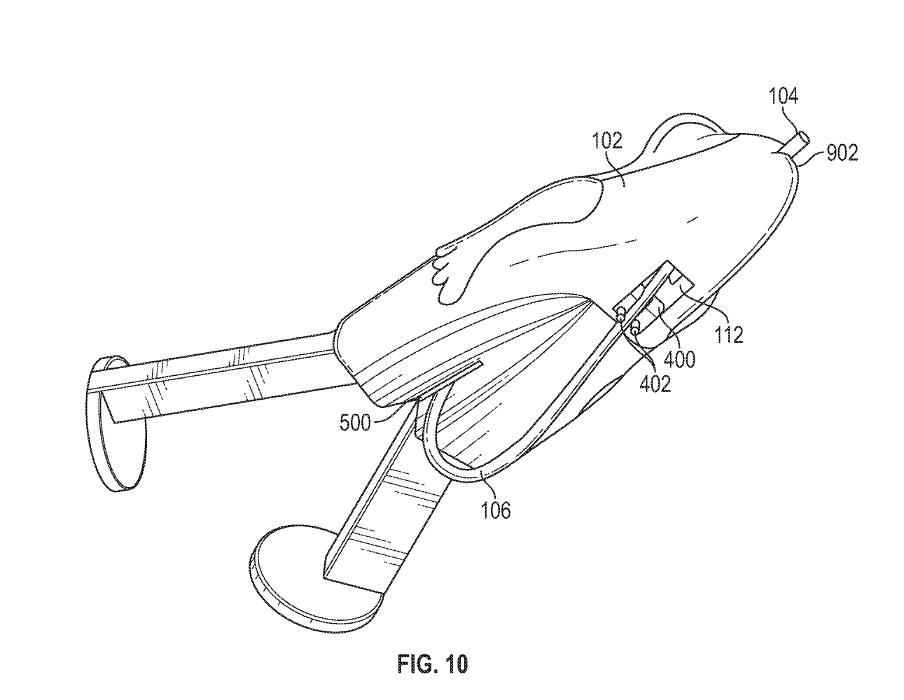

According to some embodiments, the groove 202 further includes an opening 204 positioned towards the back of the lure body 102. This opening 204 enables the hook 106 to be set in its initial retracted position over nylon plate member 500 (not shown in FIG. 2; see, e.g., FIG. 6 and FIG. 8). This opening 204 also enables the hook to be released from the lure body 102 after the hook penetrates the mouth of the fish. More specifically, when the fish bites on a back region of the lure body 102 causing the hook 106 to be extended, the angler will then see or feel the strike and pull back on the fishing rod to penetrate the hook point 110 into the fish's mouth. Instinctively, the fish will throw the lure out of its mouth. Because the fishing line 104 runs through the mouth of the lure and exits out of a hole 112 in the belly of the lure (see, e.g., FIG. 1B and FIG. 10) then according to some embodiments, the lure can slide up the fishing line 104 and remain undamaged at the same time that the fisherman is fighting the hooked fish.

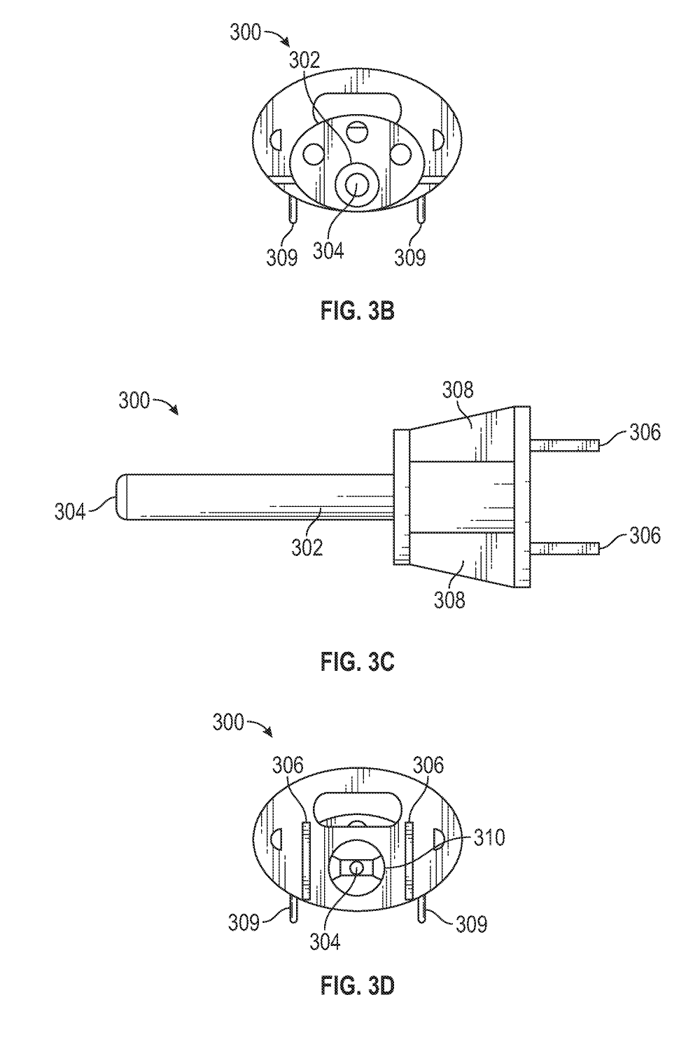

In order to secure the fish hook 106 to the lure body 102 and to thereby facilitate extending the hook 106 when the fish bites down upon a back region of the lure body 102, a number of non-metallic members may be utilized according to embodiments of the present invention. According to preferred embodiments, each of these members is made from nylon plastic material, but non-metallic materials with melting points higher than 350 degrees Fahrenheit (i.e., the preferred temperature for injection-molding the PFC plastisol used to make the lure body 102) may be used in the alternative. Each of these members is now described in turn with reference to FIGS. 3-5.

FIG. 3A is a side perspective view of a nylon tube member 300 adapted for use in an exemplary fishing lure according to embodiments of the present invention, FIG. 3B is a front view of the nylon tube member 300 depicted in FIG. 3A, FIG. 3C is a top view of the nylon tube member 300 depicted in FIG. 3A and FIG. 3B, and FIG. 3D is a back view of the nylon tube member 300 depicted in FIGS. 3A-3C.

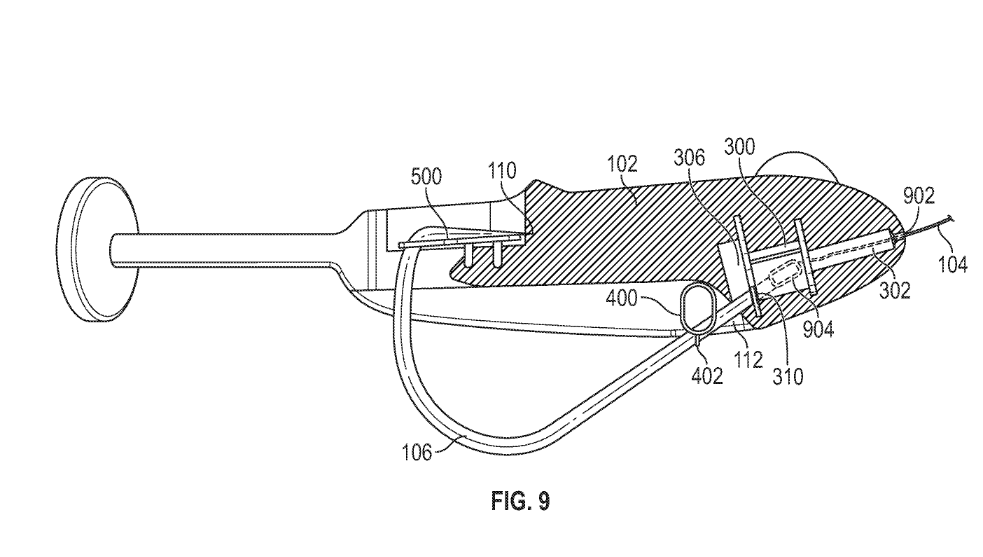

As shown by these figures, nylon tube member 300 may include a hollow tube portion 302 adapted to receive a fishing line 104 (not shown in FIGS. 3a-3d) through an opening 304. According to preferred embodiments, the nylon tube member 300 is disposed towards the front of the lure such that the fishing line 104 may be fed through the mouth of the lure body 102 into the opening 304 and then through the nylon tube member 300, exiting a slot 310 (see FIG. 3D) on the rear region of the nylon tube member 300. The fishing line 104 is then fed through a hole 112 in the belly of the lure body 102 (see FIG. 1B and FIG. 10) and is subsequently tied to the eye 904 of the fish hook 106 (not shown in FIGS. 3A-3D). The eye 904 of the fish hook 106 is then pulled back through the hole 112 in the belly of the lure body 102 and into slot 310 (see FIG. 9)

According to some embodiments, once the eye 904 of the fish hook 106 has been received into the slot 310 of the nylon tube member 300, the surface edges of the nylon tube member 300 may restrict lateral rotational motion and vertical rotational motion of the eye 904 and therefore the fish hook 106 relative to the lure body 102. The nylon tube member 300 thus helps secure the fish hook 106 to the lure body 102 in a substantially vertical orientation (thereby potentially enabling the angler to get a better hook on the fish). Additionally, the nylon tube member 300 also helps to prevent the fish hook 106 from ripping through the mouth of the lure body 102 when various forces are exerted upon the hook 106.

As shown in FIGS. 3A, 3C, and 3D, some embodiments may include line protection walls 306 adapted to prevent the fishing line 104 from pulling the nylon tube member 300 sideways and thereby ripping through the lure body 102 during operation. As shown in FIGS. 3A-3D, some embodiments may include flanges (308 and 309) adapted to retain nylon tube member 300 within the lure body 102 upon experiencing forces associated with the fish hook 106 being set upon the fish.

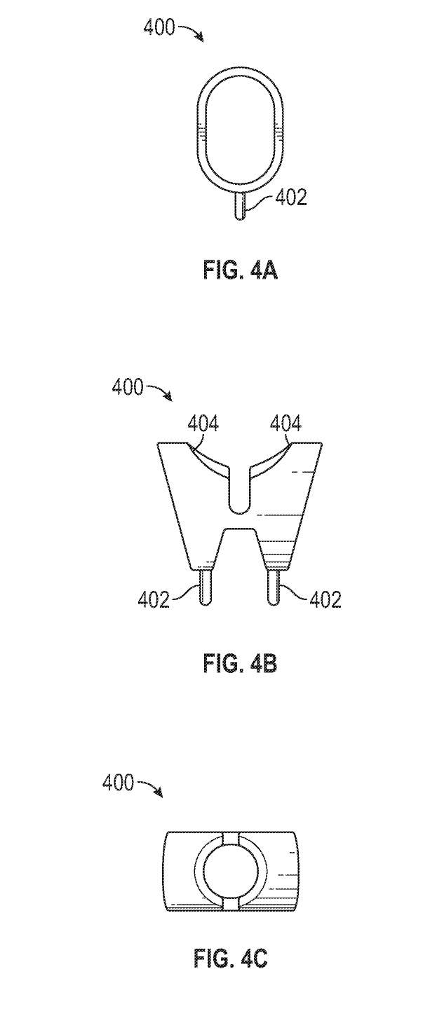

FIG. 4A is a side elevational view of a hook interfacing member 400 adapted for use in an exemplary fishing lure according to embodiments of the present invention, FIG. 4B is a front view of the hook interfacing member 400 depicted in FIG. 4A, and FIG. 4C is a top view of the hook interfacing member 400 depicted in FIG. 4A and FIG. 4B.

According to some embodiments, the hook interfacing member 400 may be made of nylon plastic and include a set of protrusions 402 adapted to restrict or substantially prevent the fish hook 106 from exhibiting lateral rotational motion relative to the lure body 102. In some embodiments, the hook interfacing member 400 may be substantially disposed within the lure body 102, with the protrusions 402 extending downward and outside of the lure body 102. The hook interfacing member 400 may receive the shank of the fish hook 106 between the protrusions 106 and thus further enable the fish hook 106 to remain in a substantially vertical orientation as various forces are exerted upon the fish hook 106 when the lure is being fished.

As shown in FIG. 4B, the sides 404 of the hook interfacing member 400 may be flared or extended sideways at an angle in order to enable the hook interfacing member 400 to retain more plastic during the molding process used to form the lure body 102 (this molding process is discussed in further detail below). In some embodiments, this shape enables the hook interfacing member 400 to be more tightly secured to the lure body 102 than if the hook interfacing member 400 had instead been formed with a straight tubular shape, for example.

According to preferred embodiments, the hook interfacing member 400 may be positioned behind and beneath the nylon tube member 300 (see, e.g., FIG. 9). Note that the leveraged tension and spring of fish hook 106 during retraction/extension can be adjusted to desired amounts by reducing the size of the hole 112 positioned between the nylon tube member 300 and the hook interacting member 400, by increasing the spacing between the hook interacting member 400 and the top of the lure, or by performing some combination of both modifications according to embodiments of the present invention.

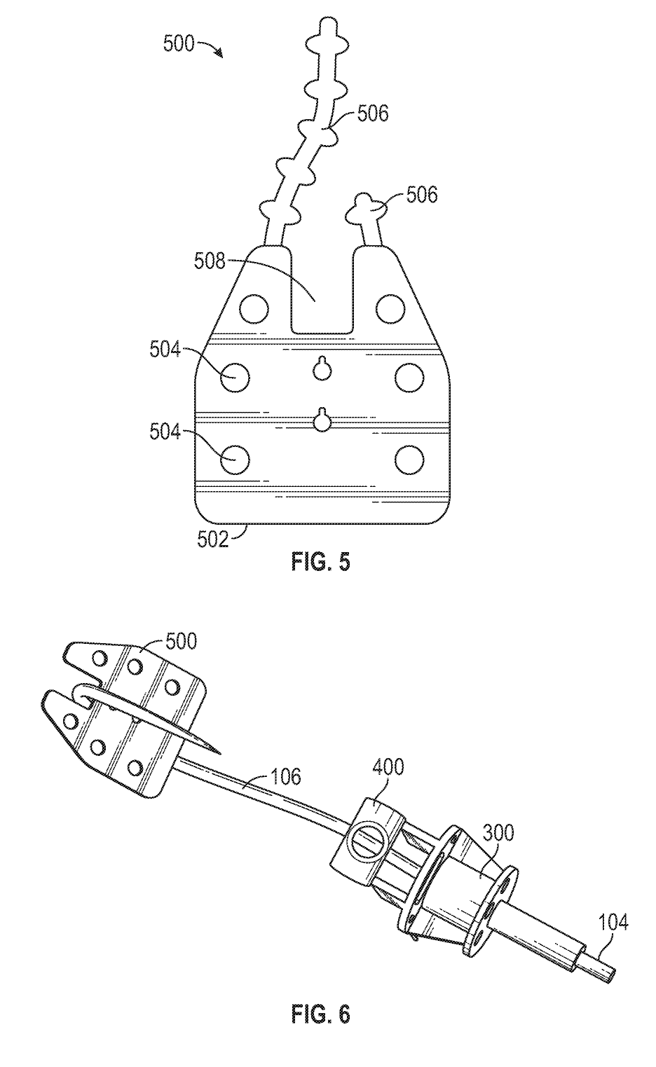

FIG. 5 is a top plan view of a nylon plate member 500 adapted for use in an exemplary fishing lure according to embodiments of the present invention. According to this figure, the nylon plate member 500 includes a nylon plate surface 502 and is oriented upon axes such that the bottom of figure points toward front of the fishing lure, while the top of the figure points toward the back of the fishing lure. According to embodiments depicted by FIG. 5, the nylon plate member 500 is flat, so side views have been omitted for simplicity. Additionally, the bottom of FIG. 500 is substantially identical to its top (albeit inverted), so bottom views have been omitted for this purpose as well.

In some embodiments, the fish hook 106 may be positioned to curve over a recess 508 in the nylon plate surface 502 so that part of the fish hook 106 sets upon (or otherwise rests slightly above) the nylon plate surface 502 when the fish hook 106 is initially placed into its retracted state (see, e.g., FIGS. 6, 8, and 9). Thus, according to some embodiments, the nylon plate member 500 restricts the point 110 and the barb 108 of the hook 106 from downward movement and downward rotational movement relative to the lure body 102. This restriction of motion helps to prevent the point 110 and barb 108 of the hook 106 from tearing through the soil material of the lure body 102 during operation.

According to preferred embodiments, the shape of the nylon plate surface 502 may be identical or substantially similar to the shape of the nylon plate surface 502 depicted in FIG. 5. Alternatively, the shape of the nylon plate surface 502 may be U-shaped or V-shaped according to embodiments of the present invention. A variety of other shapes for the nylon plate surface 502 are also possible in accordance with the scope of the present invention.

In some embodiments, the nylon plate member 500 may include one or more extensions 506 adapted to preserve the shape of the back region of the lure body 102 when the fishing lure is being moved through water. As already mentioned above with reference to FIG. 2, groove 202 includes an opening 204 for allowing the hook to release from the lure body 102 once the point 110 of the hook 106 has penetrated through the fish's mouth. Therefore, recess 508, alone with opening 204, are not completely enclosed or surrounded by PVC plastisol in order to enable this release to take effect. According to some embodiments, the extensions 508 may work in concert to prevent the opening 204 from growing wider when the lure is being moved through water. For example, in a lure body 102 formed to resemble a rat, the longer of the extensions 506 may be disposed within a portion of the lure body 102 resembling the tail of the rat. The added structural support of the lure body 102 provided by the extensions 508 thereby works to prevent the tail of the lure body 102 from flopping around when the fishing lure is being moved through water.

In order to help secure the nylon plate member 500 to the lure body 102, a number of apertures 504 may be included within the nylon plate surface 502 according to some embodiments. During the injection-molding process used to form the lure body 102 (as discussed in further detail below), the liquid PVC plastisol used to form the lure body 102 fills these apertures 504. After the PVC plastisol cools and hardens, the nylon plate member 500 subsequently becomes more tightly secured to the lure body 102.

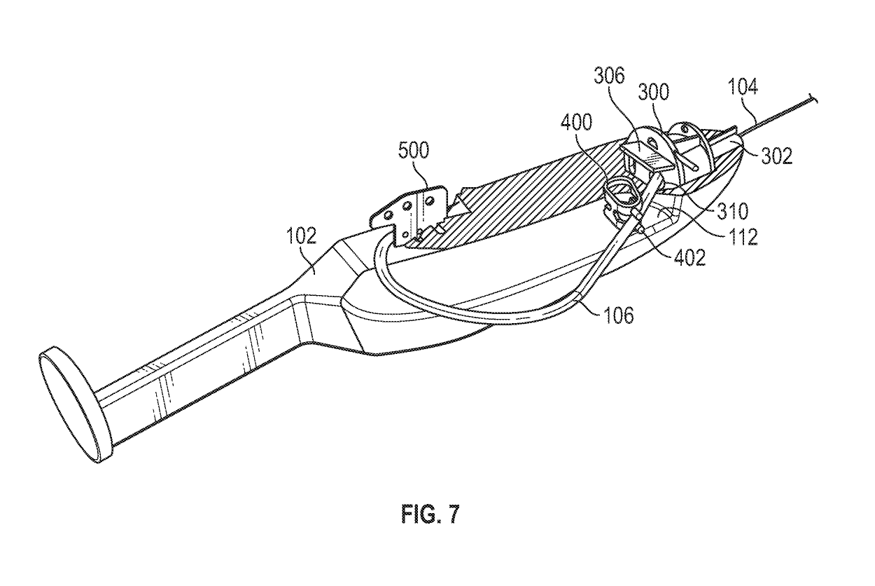

FIG. 6 is a top perspective view of an exemplary fishing lure with its lure body 102 hidden from view according to embodiments of the present invention, while FIG. 7 is bottom perspective view of an exemplary fishing lure with part of its lure body 102 hidden from view according to embodiments of the present invention. Both of these figures are provided to facilitate the reader's understanding of the relative positioning of the nylon plastic members 300, 400, and 500 since various views of the lure body 102 can often obscure the view of the nylon plastic members 300, 400, and 500.

Therefore, as shown in FIG. 6, only the nylon tube member 300, the hook interfacing member 400, the nylon plate member 500, and the fish hook 106 tied to the fishing line 104 are presented. In addition to these components depicted in FIG. 6, FIG. 7 additionally depicts a portion of the lure body 102, the protrusions 402 of the hook interfacing member 400 that are adapted for preventing lateral rotational motion of the fish hook 106 in order to substantially retain the hook 106 in a vertical position while the lure is being fished, the hole 112 in the belly of the lure body 102 (better shown in FIG. 10), the slot 310 in the back of the nylon tube member 300 adapted to receive the eye 904 of the fish hook 106 (not visible in FIG. 7; see FIG. 9), a line protection wall 306, and the hollow tube portion 302 of the nylon tube member 300 adapted to receive the fishing line 104.

In some embodiments, the nylon plastic members 300, 400, 500 depicted in FIGS. 3-10 may be disposed and secured within the lure body 102 via an injection-molding process. Prior to heating the plastisol, the nylon plastic members 300, 400, and 500 are inserted and fixed within a lure-body mold.

Optionally, one or more substances may be added to the plastisol prior to injection. These substances may include, for example, materials such as paints and laminates for giving the lure-body a specific color. In some embodiments, dual-injectors may be utilized for shooting two colors at once in order to create a two-toned colored lure body.

Water-soluble materials used in conventional olfactory fish attractants may also be added to the plastisol according to some embodiments. These materials may give the lure a specific scent (such as that associated with crayfish, garlic, shad, or anise) in order to attract the desired fish. Materials used to mask out the unpleasant scents (such as that associated with the skin oils of human beings) may also be utilized.

Floating agents may also be utilized according to some embodiments. In one embodiment, for example, a floating agent known as “micro glass bubbles” may be added to the plastisol prior to heating which decreases the density of the lure-body material (i.e. the PVC plastisol) relative to the density of water, thereby causing it to float. The micro-glass bubbles may also advantageously increase the volume of the injectable material and thereby increase the overall cost-effectiveness of lure manufacture. Other floating agents, such as air-bubbles and foam, may be used in addition to, or in lieu of, the aforementioned micro glass bubbles. In other embodiments, weighting agents may be used to add weight to the fishing lure. For example, in one preferred embodiment, sinking plastisol is used. Lead or tungsten may be utilized in the alternative.

When liquid PVC plastisol is heated to the preferred temperature of 350 degrees Fahrenheit according to various embodiments, the lure-body mold may then be injected with the heated plastisol. The nylon plastic members 300, 400, and 500 do not appreciably exhibit thermal degradation during the molding process since the nylon plastic resists melting at temperatures of up to 500 degrees Fahrenheit.

FIG. 8 is a back view of an exemplary fishing lure according to embodiments of the present invention. When the fish hook 106 is initially set in its retracted state, the fish hook 106 may be curved around the nylon plate member 500 such that a portion of the hook 106 rests upon, or is positioned slightly above, the nylon plate member 500 (see also FIG. 9). Notice that in the depicted embodiment, the fish hook 106 is positioned in the center of the lure relative to the lure's width. Nylon tube member 300 and hook interfacing member 400 (not shown in FIG. 8) assist in retaining the hook 106 in a substantially vertical orientation, i.e. perpendicular to the width of the fishing lure when the lure is normally oriented. Advantageously, the central positioning of the hook 106 and its vertical orientation potentially enables the angler to get a better hook on the fish than other conventional fishing lures which utilize off-center positioning, non-orthogonal angles for the fish hook 106, and otherwise provide limited or non-existent support for retaining the orientation of the fish hook 106 when various external forces are exerted upon it.

FIG. 9 is a side perspective view of an exemplary fishing lure according to embodiments of the present invention, while FIG. 10 is a bottom perspective view of an exemplary fishing lure according to embodiments of the present invention. Fishing line 104 is fed through the mouth 902 of the lure body 102. After the fishing line 104 is fed through the hollow tube portion 302 of the nylon tube member 300 and exits through slot 310 in the back of the nylon tube member 300 and hole 112 in the belly of the lure (best seen in FIG. 10), it is then tied to the eye 904 of the fish hook 106 and pulled back through both the hole 112 and slot 310 (best seen in FIG. 9). The shank of the hook 105 may then be positioned to run between the protrusions 402 of the hook interfacing member 400. The bend of the hook 106 may then be curved around the nylon plate member 500 such that a portion of the hook 106 rests upon, or is positioned slightly above, the nylon plate member 500 (see also FIG. 8). Advantageously, according to some embodiments, in addition to facilitating extension of the fish hook 106, the nylon plastic members 300, 400, and 500 work in concert to prevent the point 110 and the barb 108 of the hook 106 from tearing or ripping the soft-body material of the lure during operation.

Various embodiments of the soft-bodied lure described herein are therefore substantially more durable than conventional lures since during operation, they are less susceptible to rips and tears from the hook 106, the nylon plastic members 500 do not exhibit the same sharp edging associated with metallic components, the hook can release from the lure allowing the lure to slide up the fishing line undamaged while the fisherman is fighting the hooked fish, and the nylon plastic members 300, 400, and 500 are non-metallic so they will not be susceptible to oxidation/rust. Also, according to some embodiments, since the lure body 102 is formed to have a solid-body, rather than a hollow-body (as in the case of many conventional lures), grime buildup associated with continual use of the lure is substantially prevented. Additionally, according to some embodiments, since the fish hook 106 is retained in a substantially vertical orientation by the nylon plastic members 300, 400, 500 and is positioned in the center of the lure body 102 relative to its width, the angler can potentially get a better hook on a fish than in the case with many conventional lures. Moreover, since the fish hook 106 remains in its retracted state until the fish bites down on the lure, various embodiments of the lure disclosed herein are less susceptible to snagging and hang-ups than conventional fishing lures, thereby enabling fishing in areas containing weeds, algae, and various other types of matted vegetation.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A fishing lure comprising:
a lure body comprising PVC plastisol; and
a set of members, each of said members comprising nylon plastic, each of said members being at least partially disposed within the lure body, and each of said members being adapted to secure a fish hook to the lure body in a predetermined orientation;
wherein the lure body is adapted to expose the fish hook upon experiencing a collapse of a back region of the lure body.

2. The fishing lure of claim 1, wherein set of members comprises a first member adapted to receive a fishing line.

3. The fishing lure of claim 2, wherein the first member comprises a slot adapted to receive an eye of the fish hook, wherein the slat is further adapted to restrict motion of the eye of the fish hook relative to the lure body.

4. The fishing lure of claim 2, wherein the set of members comprises a second member with protrusions adapted to restrict lateral rotational motion of the fish hook relative to the lure body.

5. The fishing lure of claim 4, wherein the set of members comprises a third member comprising a surface adapted to restrict downward rotational motion of the fish hook relative to the lure body.

6. The fishing lure of claim 5, wherein the lure body comprises a groove adapted to at least partially surround a point of the fish hook when the fish hook is in a retracted position.

7. The fishing lure of claim 6, wherein the groove comprises an opening adapted to enable the fish hook to be released from the lure body.

8. A fishing lure comprising:
a lure body comprising a groove adapted to at least partially surround a point of a fish hook when the fish hook is in a retracted position on the lure body;
a first member disposed within the lure body and adapted to receive a fishing line inserted through the first member, the first member comprising a slot adapted to receive an eye of the fish hook attached to the fishing line;
a second member at least partially disposed within the lure body and positioned lower on the lure body than the first member, the second member adapted to restrict lateral rotational motion of the fish hook relative to the lure body; and
a third member disposed within the lure body and adapted to restrict downward rotational motion of the fish hook relative to the lure body.

9. The fishing lure of claim 8, wherein the lure body comprises PVC plastisol.

10. The fishing lure of claim 9, wherein the PVC plastisol comprises micro glass bubbles.

11. The fishing lure of claim 9, wherein the PVC plastisol comprises sinking plastisol.

12. The fishing lure of claim 8, wherein the lure body comprises rubber.

13. The fishing lure of claim 8, wherein each of said first, second, and third members comprise nylon plastic.

14. The fishing lure of claim 8, wherein at least a portion of the lure body surrounding the groove protrudes outwardly to prevent exposure of the point of the fish hook when the fish hook is in the retracted position.

15. The fishing lure of claim 8, wherein the groove comprises an opening adapted to enable the fish hook to be released from the lure body.

16. The fishing lure of claim 8, wherein the first member comprises flanges adapted to secure the first member to the lure body.

17. The fishing lure of claim 8, wherein the first member comprises walls adapted to prevent the fishing line from ripping the lure body.

18. The fishing lure of claim 8, wherein the third member comprises a nylon plate.

19. The fishing lure of claim 18, wherein the nylon plate comprises a set of one or more apertures adapted to secure the third member to the lure body upon molding.

20. The fishing lure of claim 19, wherein the nylon plate comprises one or more extensions adapted to preserve the shape of a back region of the lure body when the lure body is being moved through water.
